(19) United States
(12) Patent Application Publication
(10) Pub. No.: US 2013/0173662 A1
(43) Pub. Date: Jul. 4, 2013

(54) DEPENDENCY BASED PRIORITIZATION OF SUB-QUERIES AND PLACEHOLDER RESOLUTION

(71) Applicants: Todd E. Kaplinger, Raleigh, NC (US); Ethan K. Merrill, Durham, NC (US); Barton C. Vashaw, Apex, NC (US)

(72) Inventors: Todd E. Kaplinger, Raleigh, NC (US); Ethan K. Merrill, Durham, NC (US); Barton C. Vashaw, Apex, NC (US)

(73) Assignee: International Business Machines Corporation, Armonk, NY (US)

(21) Appl. No.: 13/342,415

(22) Filed: Jan. 3, 2012

(51) Int. Cl. G06F 17/30

(52) U.S. Cl. 707/774; 707/E17.014

(57) ABSTRACT

A search tool determines a plurality of sub-queries from a query submitted to the search tool. For each of the plurality of sub-queries, the search tool determines dependencies among the plurality of sub-queries using dependency information. The dependency information indicates dependencies among the plurality of sub-queries based on structure of a plurality of data sources and/or structures of a plurality of data views provided by the search tool. Placeholders for expected results of at least a subset of the plurality of sub-queries that are dependent sub-queries are created. The placeholders are registered with a distribution service using the placeholder identifiers. For each of the subset of the plurality of sub-queries, a modified sub-query that indicates the identifier for the placeholder that corresponds to the sub-query is generated. The modified sub-queries are submitted to the plurality of data sources in accordance with the dependencies.

### BACKGROUND

Embodiments of the inventive subject matter generally relate to the field of computers and, more particularly, to processing of asynchronous results for a search query received by client.

A search query is associated with a request for a set of data based on a specified criteria. Results of the search query can be displayed in various configurations, also termed as data views. For example, for a search query returning flights on a particular day, one data view can be a list of flights according to price. Another data view can be a list of flights according to time of day. A user is presented with an initial data view based on a default configuration, and is presented options to select additional data views.

### SUMMARY

Embodiments of the inventive subject matter include a method for prioritizing sub-queries based on dependencies. The method determines a plurality of sub-queries from a query submitted to a search tool. For each of the plurality of sub-queries, the method determines dependencies among the plurality of sub-queries using dependency information. The dependency information indicates dependencies among the plurality of sub-queries based on at least one of structure of a plurality of data sources corresponding to the plurality of sub-queries and structures of a plurality of data views of query results provided by the search tool. Placeholders for expected results of at least a subset of the plurality of sub-queries that are dependent sub-queries are created. Creating the placeholders comprises creating identifiers for the placeholders. The placeholders are registered with a distribution service using the placeholder identifiers. The distribution service operates as an intermediary posting facility for results of the subset of the plurality of sub-queries to be supplied to a requestor associated with the query. For each of the subset of the plurality of sub-queries, a modified sub-query that indicates the identifier for the placeholder that corresponds to the sub-query is generated. The modified sub-queries are submitted to appropriate ones of the plurality of data sources in accordance with the dependencies among the plurality of sub-queries.

Embodiments of the inventive subject matter also include a computer program product for prioritizing replacement of placeholders based on dependency information. The computer program product comprises a computer readable storage medium having computer usable program code embodied therewith. The computer usable program code comprises a computer usable program code configured to determine dependencies of a plurality of placeholders used in a plurality of data views provided by a search tool to present results of sub-queries. The dependencies are determined with dependency information that is based, at least in part, on structures of the plurality of data views. For each of the plurality of placeholders in accordance with the dependencies, the computer usable program code is configured to generate a request for a sub-query result that corresponds to the placeholder, and to submit the request to a result distribution service. The request indicates an identifier for the placeholder. The result distribution service operates as a posting facility for results of the plurality of sub-queries, which are provided asynchronously to the result distribution service. The computer usable program code is configured to replace the placeholders as the corresponding sub-query results are received from the result distribution service.

### BRIEF DESCRIPTION OF THE DRAWINGS

The present embodiments may be better understood, and numerous objects, features, and advantages made apparent to those skilled in the art by referencing the accompanying drawings.

FIGS. 1-3 depict conceptual diagram of different uses of dependency information. The figures illustrate example scenarios with dependency information available to a client, to a server, and to both a client and a server.

FIG. 1 depicts a conceptual diagram that illustrates client aggregation of asynchronously received sub-query results with dependency graphs at both client and server.

FIG. 2 depicts a conceptual diagram that illustrates a server using a dependency graph at the server to decompose a query.

FIG. 3 depicts a conceptual diagram that illustrates a client using a client dependency graph to decompose a query and to aggregate asynchronously received sub-query results.

FIG. 4 illustrates a flow diagram of example operations for decomposing a query into independent and dependent sub-queries using a dependency graph.

FIG. 5 illustrates a flow diagram of example operations to resolve placeholders using a dependency graph.

FIG. 6 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to a result distribution service, embodiments do not require a result distribution service. In other instances, well-known instruction instances, protocols, structures and techniques have not been shown in detail in order not to obfuscate the description. For instance, dependency information can be formatted in accordance with various data interchange formats (e.g., eXtensible markup language or JavaScript® Object Notation (JSON)).

A search tool/application (hereinafter “search tool”) can present different data views of a query result(s). Examples of data views include a map, a graph or chart, and a document (e.g., web page, word processing document, a spreadsheet document, etc.). The data views can be rendered in a web browser, a native application, a data viewing tool, etc. To provide the query result(s), a machine(s) serving the query (e.g., a server) often accesses multiple data sources and/or performs multiple accesses with different keys or indices into a data source(s). Data sources comprise elements that can be data fields and/or computational resources. For an expansive data source and/or complex query, the time to present a data view of a query result can be noticeable for a user. In addition, the user may select a different data view that triggers another query for additional data corresponding to the different data view. The data views often comprise multiple units of data (e.g., dates, names, titles, codes, descriptions, etc.) returned responsive to processing a query. The search tool aggregates the multiple units of data for a data view as the data arrive, but the delivery of the units of data can introduce delay into presenting the data view. To efficiently process a query, the search tool decomposes the query into sub-queries and determines dependencies among the sub-queries. The search tool prioritizes the independent sub-queries over the dependent sub-queries for efficient processing. A data unit supplied responsive to a sub-query (hereinafter “sub-query result”) can be used by multiple data views and a data view can utilize multiple sub-queries. To improve user experience, a search tool can employ placeholders to present a data view of a partial query result. The search tool inserts the placeholders into the data view for sub-query results not yet available, and replaces the placeholders with the appropriate sub-query results once supplied.

The search tool uses information about dependencies between sub-queries for a data view. A variety of implementations are possible for the dependency information (e.g., a tree structure, graph structure, table structure, hybrid data structure, etc.). For this description, the dependency information will be referred to as a dependency graph, although the term should not be used to limit the scope of the claims to any particular implementation. The search tool uses a dependency graph to decompose a query into independent sub-queries and dependent sub-queries. Independent sub-queries are not dependent on sub-query result(s) of another sub-query(ies). Dependent sub-queries are dependent on sub-query result(s) of another sub-query(ies). The search tool also uses a dependency graph to prioritize resolving placeholders (i.e., fetching sub-query results to replace the corresponding placeholders). In some embodiments, the dependency graph is used for successive completion of data views on reception of sub-query results. In other embodiments, the dependency graph is used to prioritize requests for fetching sub-query results and successively completing the data views on reception of sub-query results. With the dependency graph, the search tool presents data views, whether partial or complete, with less delay and prioritizes placeholder resolution to react to changes in data views more quickly and to complete a data view more quickly.

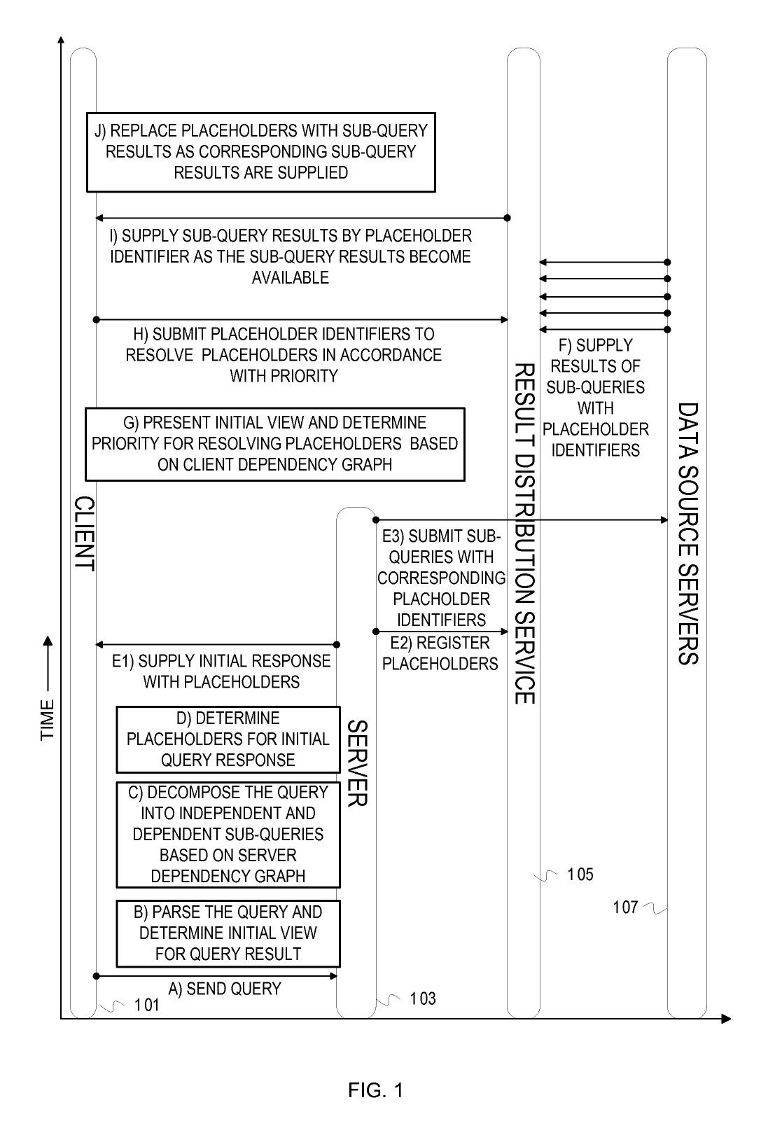

FIGS. 1-3 depict conceptual diagram of different uses of dependency information. The figures illustrate example scenarios with dependency information available to a client, to a server, and to both a client and a server.

FIG. 1 depicts a conceptual diagram that illustrates client aggregation of asynchronously received sub-query results with dependency graphs at both client and server. FIG. 1 depicts multiple entities including a client 101, a server 103, a result distribution service 105, and data source servers 107. The result distribution service 105 operates as a posting facility for results provided by the data source servers 107. The interaction between entities is illustrated in a time sequence, with time represented on a vertical axis. Flow of information between entities is illustrated by directed arrows. Processes occurring at an entity are described in text boxes partially covering the entity.

The client 101 sends queries and processes results received responsive to the queries. The server 103 initially processes queries from the client 101. The server 103 decomposes the queries into dependent sub-queries and independent sub-queries with a dependency graph, and determines initial data views for the queries. The server 103 determines placeholders to be used, and initiates asynchronous processing of sub-queries by the data source servers 107, and perhaps the server 103. The server 103 presents to the client 101 initial data view along with placeholders. The result distribution service 105 receives sub-query results from the data source servers 107. The client 101 interacts with the result distribution service 105 to resolve placeholders in accordance with dependency information. The result distribution service 105, can run on the server 103, on the data source servers 107, or separate server(s).

Stages A-C depict initial processing that occurs at the client 101 and the server 103. At stage A, the client 101 sends a query to the server 103. At stage B, the server 103 parses the query received from the client 101, and determines an initial data view for the query result. The server 103 determines the initial data view with metadata associated with the query. The metadata indicates user preferences, client settings, default settings, etc. For example: a query for flights between two particular airports on a particular day is associated with an initial data view as a list of all the flights by departure time and the airports. At stage C, the server 103 decomposes the query into dependent and independent sub-queries using a server side dependency graph. The server side dependency graph indicates information about dependencies corresponding to the sub-queries. The dependency information includes information about any one of the initial data view, popular data views, all possible data views, structure of data sources, search tool configuration, etc. For example, a server side dependency graph indicates that flight price is dependent on seat availability, departure time, and seasonal trend. A query requests flights for a particular date, and the initial data view presents the flight departure times and prices. The server 103 uses the dependency information to decompose the example flight query into an independent sub-query for flights by the time indicated in the example flight query and a dependent sub-query for seasonal trend based on the time indicated in the example flight query. The server 103 also decomposes the example flight query into dependent sub-queries for flight prices and seat availability. These dependent sub-queries are dependent on sub-query results of the independent sub-query of flights by time and airports. Dependencies are n:1 and are not limited to 1:1.

Stages D-E3 depict processing that occurs at the server 103 after the initial query has been decomposed based on the server dependency graph. At stage D, the server 103 determines placeholders for an initial query response. The initial query response will indicate readily available sub-query results and placeholders for sub-query results not readily available. Readily available sub-query results include sub-query results of independent sub-queries that are readily accessible by the server 103 for serving to the client 101 (e.g., the server 103 manages or hosts a data source corresponding to an independent sub-query). The server 103 creates placeholders with identifiers (“placeholder identifiers”) for those sub-query results that are not readily available. At stage E1, the server 103 supplies at least the initial query response with placeholders. The initial query response corresponds to the initial data view. But the server 103 can also supply data and placeholders in the response (or subsequent responses) for alternative data views, secondary data views, etc., based on metadata and/or configuration data. At stage E2, the server 103 registers the placeholders with the result distribution service 105. The server 103 communicates the placeholder identifiers to the result distribution service 105. The result distribution service 105 allocates storage/memory for sub-query results that correspond to the placeholders. The result distribution service 105 also establishes services or threads to handle receipt and delivery of the sub-query results corresponding to the placeholders. At stage E3, the server 103 submits the sub-queries, which were not processed by the server 103, to the data source servers 107. In some embodiments, the server 103 submits the sub-queries as a batch of requests, while in some embodiments the server 103 submits sub-queries as separate requests. The server 103 communicates the sub-queries with indications of the corresponding placeholder identifiers to the data source servers 107. Embodiments are not limited to performing the stages E1-E3 as depicted. In some embodiments, the placeholders are first registered with the result distribution service. In some embodiments, stages E1 and E2 are performed in parallel. In other embodiments, the sub-queries are submitted prior to supplying the initial response to the client. After stages E1-E3, resources allocated at the server 103 for processing the query can be relinquished.

Stages F-J depict processing that occurs among the client 103, the result distribution service 105, and the data source servers 107. At stage F, the data source servers 107 asynchronously post/supply sub-query results of the submitted sub-queries to the result distribution service 105. The data source servers 107 supply the sub-query results with indications of the appropriate placeholder identifiers. The result distribution service 105 stores the sub-query results in accordance with the placeholder identifiers. At stage G, the client 101 presents the initial data view based on the initial query response from the server 103. As described earlier, the initial response comprises placeholders. In some embodiments, the client 101 uses a client dependency graph to determine priority for resolving the placeholders. The client 101 establishes priority for resolving placeholders based on the dependencies indicated in the client dependency graph. For example the client dependency graph indicates flight price data is dependent on seat availability and seasonal trend data. The client 103 prioritizes resolution of the placeholder for seat availability over the flight price placeholder. In some embodiments, the client maintains a different dependency graph for each data view. In some embodiments, the dependency graph indicates relationships among data views and data for the data views. In other words, the client uses the dependency graph to determine a price data view of flights is dependent on several pieces of data. Although FIG. 1 depicts stage G after stage F, the operations depicted at stages F and G more likely do not occur serially. Stage F represents an ongoing set of operations until the data source servers 107 supply sub-query results for the submitted sub-queries. The data source servers 107 can supply the sub-query results to the result distribution service 105 in one operation or multiple operations in stage F. At stages H and I, the client 101 and the result distribution service 105 interact. At stage H, the client 101 begins submitting placeholder identifiers to the result distribution service 105. The client 101 submits the placeholder identifiers to request corresponding sub-query results to resolve the placeholders. The client 101 submits the placeholder identifiers in accordance with the priority determined using the client dependency graph. At stage I, the result distribution service 105 begins supplying sub-query results by placeholder identifiers in response to the client 101 requests. The sub-query results can arrive at the client 101 synchronously or asynchronously with respect to the requests made by the client 101. At stage J, the client 101 replaces placeholders with corresponding sub-query results supplied from the result distribution service 105 in accordance with the client dependency graph. In some embodiments, a client replaces placeholders as sub-query results are supplied. In some cases, the timing of result delivery does not comport with priority. Priority may be based on both dependency information and configuration data. For instance, a result may not be dependent on any other unavailable result, but a graph without the other unavailable result will cause a graph to be rendered with a question mark or flag that the graph is only partially complete. A configuration may specify that partial data views of graphs are not to be presented. Some embodiments will queue a result to comport with priority, while some embodiments will replace placeholders as corresponding sub-query results are supplied.

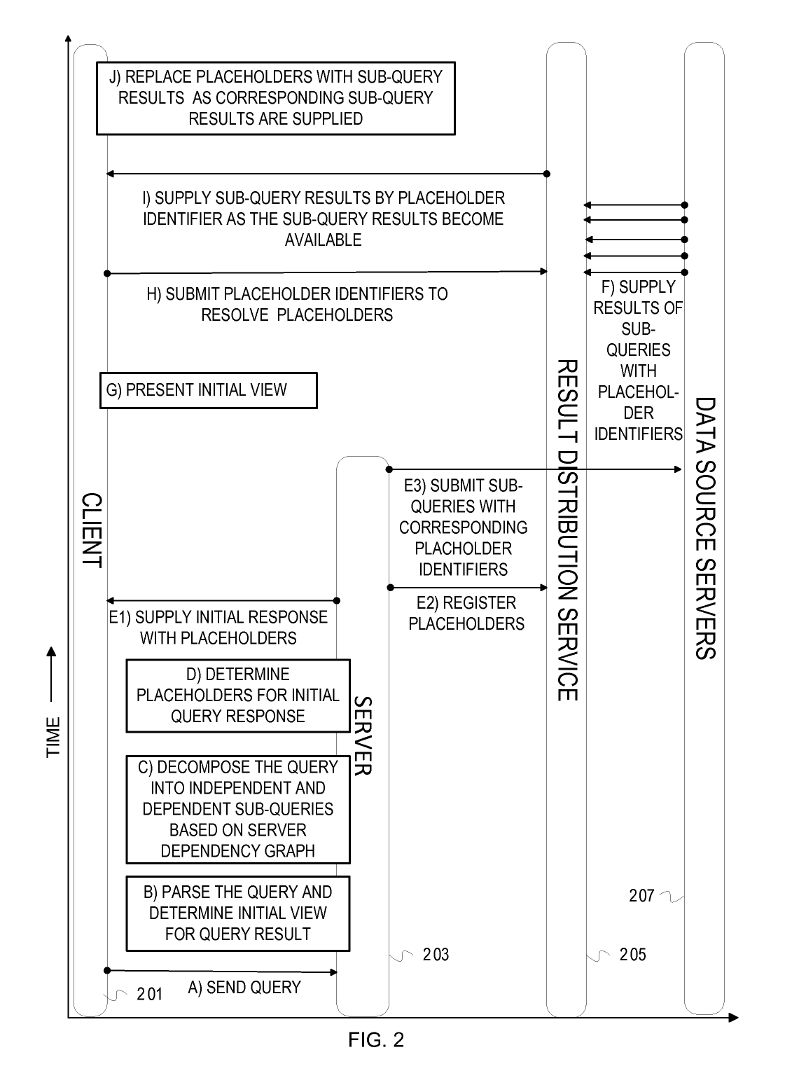

FIG. 2 depicts a conceptual diagram that illustrates a server using a dependency graph at the server to decompose a query. FIG. 2 depicts multiple entities including a client 201, a server 203, a result distribution service 205, and data source servers 207. The interaction between entities and flow of information is illustrated in the same manner as in FIG. 1. FIG. 2 depicts states A-F, which are similar to the stages A-F depicted in FIG. 1.

The client 201 sends queries and processes results received responsive to the queries. The server 203 initially processes queries from the client 201. The server 203 decomposes the queries into dependent sub-queries and independent sub-queries with a server dependency graph, and determines initial data views for the queries. The server 203 determines placeholders to be used, and initiates asynchronous processing of sub-queries by the data source servers 207, and perhaps the server 203. The server 203 presents to the client 201 initial data view along with placeholders. The result distribution service 205 receives sub-query results from the data source servers 207. The client 201 interacts with the result distribution service 205 to resolve placeholders. The result distribution service 205, can run on the server 203, on the data source servers 207, or separate server(s).

Stages A-C depict initial processing that occurs at the client 201 and the server 203. At stage A, the client 201 sends a query to the server 203. At stage B, the server 203 parses the query received from the client 201, and determines an initial data view for the query result. The server 203 determines the initial data view with metadata associated with the query. The metadata indicates user preferences, client settings, default settings, etc. At stage C, the server 203 decomposes the query into dependent and independent sub-queries using a server dependency graph. The server dependency graph indicates information as described with reference to FIG. 1.

Stages D-E3 depict processing that occurs at the server 203 after the initial query has been decomposed based on the server dependency graph. At stage D, the server 203 determines placeholders for an initial query response. The initial query response will indicate readily available sub-query results and placeholders for sub-query results not readily available. Readily available sub-query results include sub-query results of independent sub-queries that are readily accessible by the server 203 for serving to the client 201 (e.g., the server 203 manages or hosts a data source corresponding to an independent sub-query). The server 203 creates placeholders with placeholder identifiers for those sub-query results that are not readily available. At stage E1, the server 203 supplies at least the initial query response with placeholders. The initial query response corresponds to the initial data view. But the server 203 can also supply data and placeholders in the response (or subsequent responses) for alternative data views, secondary data views, etc., based on metadata and/or configuration data. At stage E2, the server 203 registers the placeholders with the result distribution service 205. The server 203 communicates the placeholder identifiers to the result distribution service 205. The result distribution service 205 allocates storage/memory for sub-query results that correspond to the placeholders. The result distribution service 205 also establishes services or threads to handle receipt and delivery of the sub-query results corresponding to the placeholders. At stage E3, the server 203 submits the sub-queries, which were not processed by the server 203, to the data source servers 207. In some embodiments, the server 203 can submit the sub-queries as a batch of requests, while in some embodiments the server 203 can submit sub-queries as separate requests. The server 203 communicates the sub-queries with indications of the corresponding placeholder identifiers to the data source servers 207. Embodiments are not limited to performing the stages E1-E3 as depicted. In some embodiments, the placeholders are first registered with the result distribution service. In some embodiments, stages E1 and E2 are performed in parallel. In other embodiments, the sub-queries are submitted prior to supplying the initial response to the client. After stages E1-E3, resources allocated at the server 203 for processing the query can be relinquished.

Stages F-J depict processing that occurs among the client 203, the result distribution service 205, and the data source servers 207. At stage F, the data source servers 207 asynchronously supply sub-query results of the submitted sub-queries to the result distribution service 205. The data source servers 207 supply the sub-query results with indications of the appropriate placeholder identifiers. The result distribution service 205 stores the sub-query results in accordance with the placeholder identifiers. At stage G, the client 201 presents the initial data view based on the initial query response from the server 203. Depending on client settings, the client 201 presents the initial data view after receiving the initial response from the server at stage E1. With some settings, the client 201 presents the initial data view with placeholders for results not yet available. With other settings, the client 201 will refrain from presenting a partial data view. Although FIG. 2 depicts stage G after stage F, the operations depicted at stages F and G more likely do not occur serially. Stage F represents an ongoing set of operations until the data source servers 207 supply sub-query results for the submitted sub-queries. The data source servers 207 can supply the sub-query results to the result distribution service 205 in one operation or multiple operations in stage F. At stages H and I, the client 201 and the result distribution service 205 interact. At stage H, the client 201 begins submitting placeholder identifiers to the result distribution service 205. The client 201 submits the placeholder identifiers to request corresponding sub-query results to resolve the placeholders. The client 201 can submit individual placeholder identifiers, or a batch of placeholder identifiers, or a combination of both. At stage I, the result distribution service 205 begins supplying sub-query results by placeholder identifiers in response to the client 201 requests. The sub-query results can arrive at the client 201 synchronously or asynchronously with respect to the requests made by the client 201. At stage J, the client 201 replaces placeholders with corresponding sub-query results supplied from the result distribution service 205. In some embodiments, a client replaces placeholders as sub-query results are supplied. In some cases, the timing of result delivery does satisfy configuration data. For instance, configuration data may specify that partial data views of a graph are not to be presented. Thus, delivery of some of the results for a data view of the graph does not satisfy configuration data. Some embodiments will queue results until configuration data is satisfied, while some embodiments will replace placeholders as corresponding sub-query results are supplied.

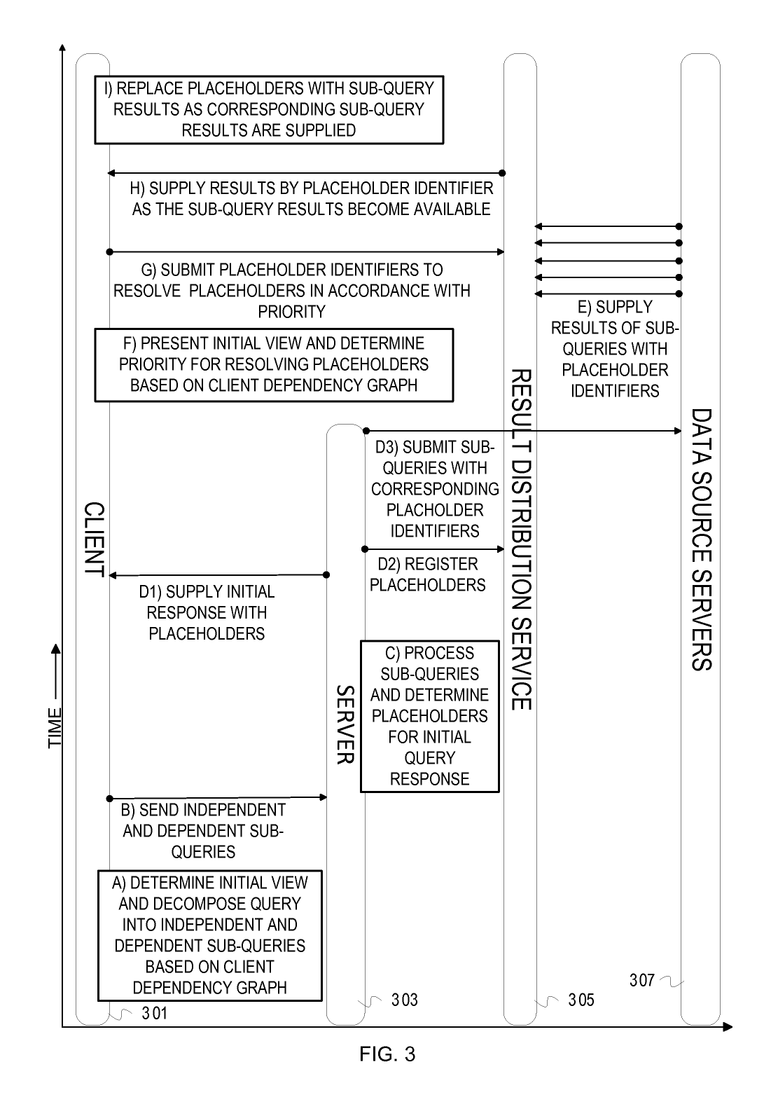

FIG. 3 depicts a conceptual diagram that illustrates a client using a client dependency graph to decompose a query and to aggregate asynchronously received sub-query results. As with FIGS. 1-2, FIG. 3 depicts multiple entities including a client 301, a server 303, a result distribution service 305, and data source servers 307. The interaction between entities and flow of operations is again illustrated as in FIGS. 1-2.

The client 301 determines initial data views for the queries and decomposes the queries into independent and dependent sub-queries based on a dependency graph. The client 301 sends independent and dependent sub-queries to the server 303. The server 303 initially processes sub-queries from the client 301. The server 303 determines placeholders to be used, and initiates asynchronous processing of sub-queries by the data source servers 307, and perhaps the server 303. The server 303 presents to the client 301 results of sub-queries serviced by the server 303, and placeholders for results of sub-queries not serviced by the server 303. The result distribution service 305 receives sub-query results from the data source servers 307. The client 301 interacts with the result distribution service 305 to resolve placeholders in accordance with dependency information. The result distribution service 305, can run on the server 303, on the data source servers 307, or separate server(s).

Stages A-B depict initial processing that occurs at the client 301. At stage A, the client 301 parses a query and determines an initial data view for the query result. The client 301 determines the initial data view with metadata associated with the query. The metadata indicates user preferences, client settings, default settings, etc. At stage A, the client 301 also decomposes the query into dependent and independent sub-queries using a client side dependency graph. The client side dependency graph indicates information about dependencies corresponding to the sub-queries. The dependency information includes information about any one of the initial data view, popular data views, all possible data views, structure of data sources, search tool configuration, etc. The dependent sub-queries are dependent on sub-query results of the independent sub-queries and possibly other dependent sub-queries. Dependencies are n:1 and are not limited to 1:1. At stage B, the client 301 sends independent and dependent sub-queries to the server 303. The client 301 prioritizes communicating the independent sub-queries over the dependent sub-queries. In some embodiments, the client 301 prioritizes transmission of the sub-queries. In some embodiments, the client 301 transmits the sub-queries in batches and prioritizes the sub-queries by marking the independent sub-queries or indicating the independent sub-queries earlier in the batch request. The sub-queries in stage B can be sent as a batch of requests, as individual requests or a combination of both.

Stages C-D3 depict processing that occurs at the server 303 after the client 301 begins communicating the independent and dependent sub-queries. At stage C, the server 303 prepares an initial query response, and determines placeholders for the initial query response. The initial query response will indicate readily available sub-query results and placeholders for sub-query results not readily available. Readily available sub-query results include sub-query results of independent sub-queries that are readily accessible by the server 303 for serving to the client 301. The server 303 creates placeholders with placeholder identifiers for those sub-query results that are not readily available. At stage D1, the server 303 supplies at least the initial query response with placeholders. The initial query response may provide some, all or no parts for the initial data view as determined by the client 301. The server 303 can also supply results and placeholders in the response (or subsequent responses) for alternative data views, secondary data views, etc., based on metadata and/or configuration data. At stage D2, the server 303 registers the placeholders with the result distribution service 305. The server 303 communicates the placeholder identifiers to the result distribution service 305. The result distribution service 305 allocates storage/memory for sub-query results that correspond to the placeholders. The result distribution service 305 also establishes services or threads to handle receipt and delivery of the sub-query results corresponding to the placeholders. At stage D3, the server 303 submits the sub-queries, which were not processed by the server 303, to the data source servers 307. In some embodiments, the server 303 submits the sub-queries as a batch of requests, while in some embodiments the server 303 submits sub-queries as separate requests. The server 303 communicates the sub-queries with indications of the corresponding placeholder identifiers to the data source servers 307. Embodiments are not limited to performing the stages D1-D3 as depicted. In some embodiments, the placeholders are first registered with the result distribution service. In some embodiments, stages D1 and D2 are performed in parallel. In other embodiments, the sub-queries are submitted prior to supplying the initial response to the client. After stages D1-D3, resources allocated at the server 303 for processing the sub-queries can be relinquished.

Stages E-I depict processing that occurs among the client 303, the result distribution service 305, and the data source servers 307. At stage E, the data source servers 307 asynchronously supply sub-query results of the submitted sub-queries to the result distribution service 305. The data source servers 307 supply the sub-query results with indications of the appropriate placeholder identifiers. The result distribution service 305 stores the sub-query results in accordance with the placeholder identifiers. At stage F, the client 301 presents the initial data view based on the initial query response from the server 303. In some embodiments, the client 301 uses a client dependency graph to determine priority for resolving the placeholders. The client 301 establishes priority for resolving placeholders based on the dependencies indicated in the client dependency graph. For example, the price of flights is dependent on seat availability and seasonal trend as mentioned in an example for FIG. 1. In some embodiments, the client maintains a different dependency graph for each data view. In some embodiments, the dependency graph indicates relationships among data views and data for the data views. Although FIG. 3 depicts stage E after stage F, the operations depicted at stages E and F more likely do not occur serially. Stage E represents an ongoing set of operations until the data source servers 307 supply sub-query results for the submitted sub-queries. The data source servers 307 can supply the sub-query results to the result distribution service 305 in one operation or a multiple operations in stage E. At stages G and H, the client 301 and the result distribution service 305 interact. At stage G, the client 301 begins submitting placeholder identifiers to the result distribution service 305. The client 301 submits the placeholder identifiers to request corresponding sub-query results to resolve the placeholders. The client 301 submits the placeholder identifiers in accordance with the priority determined using the client dependency graph. At stage H, the result distribution service 305 begins supplying sub-query results by placeholder identifiers in response to the client 301 requests. The sub-query results can arrive at the client 301 synchronously or asynchronously with respect to the requests made by the client 301. At stage I, the client 301 replaces placeholders with corresponding sub-query results supplied from the result distribution service 305 in accordance with the client dependency graph. In some embodiments, a client resolves placeholders as sub-query results are supplied. In some cases, the timing of result delivery does not comport with priority. Priority may be based on both dependency information and configuration data. For instance, a result may be not be dependent on any other unavailable result, but a graph without the other unavailable result will cause a graph to be rendered with a question mark or flag that the graph is only partially complete. A configuration may specify that partial data views of graphs are not to be presented. Some embodiments will queue a result to comport with priority, while some embodiments will replace placeholders as corresponding sub-query results are supplied.

Embodiments can build the dependency graph in accordance with various techniques. In some embodiments, dependency information is pre-configured or encoded into the search tool or as a separate file(s). A developer, who is aware of the data source structures and/or relationships between data views, codes the dependency information. The search tool later reads or loads the dependency information for decomposing a query. In some embodiments, the search tool evaluates sub-queries for data views. Data view may be added and/or modified after deployment of the search tool. The search tool analyzes the code that implements the data views to determine inputs and outputs (e.g., parameters passed into and from functions) among functions/procedures that implement the data views. The search tool creates the dependency information based on determining which functions depend on output from other functions as input, and which functions do not. For example, a code (referred to herein as “dependency builder code”), which can be part of a search tool or separate from the search tool, analyzes code for an intellectual property search tool. The builder code determines that a function for an initial data view of issued U.S. patents takes specified criteria and accesses a first data source of issued U.S. patents to present a list of the U.S. patents that satisfy the criteria. The builder code determines that a data view of inventors of the list of U.S. patents requires accessing a second data source of inventors by the patent numbers of the returned list of U.S. patents. The builder code further determines that a data view of corresponding foreign filings requires accessing a third data source by the disclosure numbers associated with the U.S. patents. Thus, the builder code builds dependency information that indicates a query for the inventor data view is dependent on a result of the U.S. patent data view. The builder code also builds the dependency information to indicate that the foreign filing data view is dependent on the result of the U.S. patent data view and disclosure numbers thereof. In some embodiments, the search tool adapts to changes in the data sources and/or the search tool itself. For example, the search tool can adapt dependency information to account for an additional data source and modifications to data views.

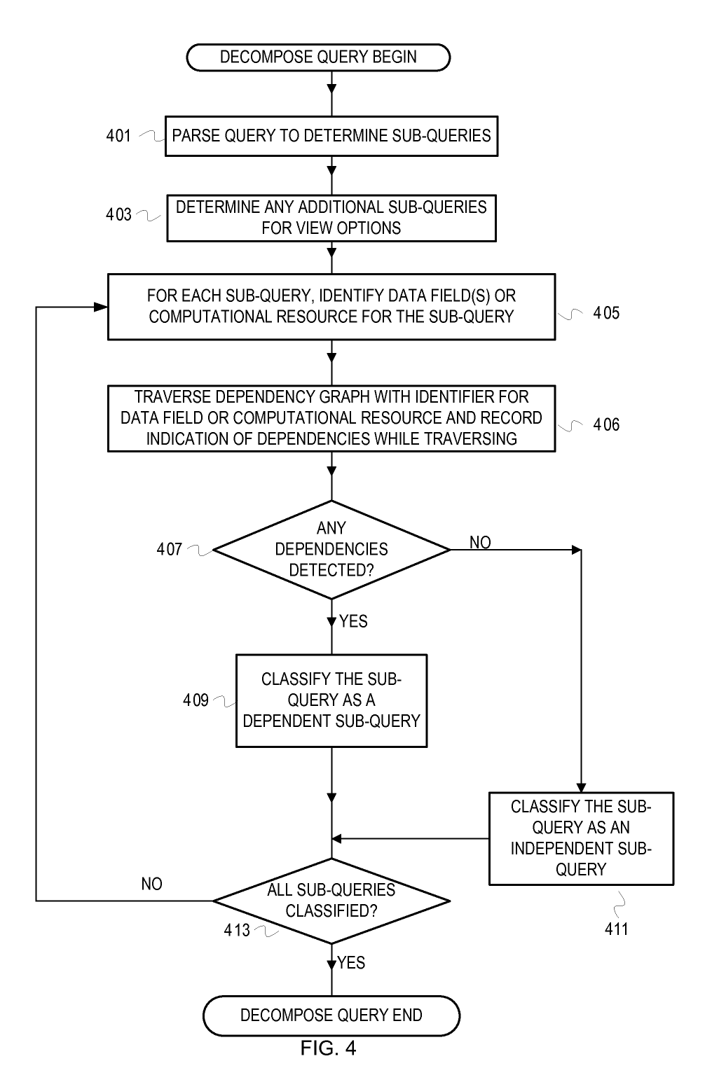

FIG. 4 illustrates a flow diagram of example operations for decomposing a query into independent and dependent sub-queries using a dependency graph. The operations in flow diagram can be performed by a client or a server. For the example depicted by FIG. 4, the operations are described as if performed by a server.

At block 401, the server parses the query. The server parses the query to determine sub-queries based on knowledge of the data sources to be accessed to respond to the query. For example, the query may be for flights by price for a particular departure date and for a departure airport and destination airport. A search tool will determine that a response to the query involves a first sub-query to a flight schedule data source, and a second sub-query to a data source of seat availability, and a third sub-query to a server that computes flight prices based on flight time and seat availability. Thus, the search tool decomposes the query into at least three sub-queries. In addition, the server may generate sub-queries for other possible data views based on metadata associated with the query and/or configuration data of the query source. For example, the server generates additional sub-queries for a data view based on number of layovers and length of layovers.

At block 403, the server determines any additional sub-queries for data view options. Although a result of the query is presented in accordance with a particular data view, another/alternative data view may be proffered and/or other data views may be selected after the query is submitted. The server determines the other data views with a variety of example techniques that can include communicating metadata that indicates the data views, perhaps in the query; supplying configuration data from the client to the server; configuring the alternative/additional data views at the server; and programming a search tool implemented by the server to offer the additional/alternative data views of query results based on various factors (e.g., data sources, type of query, source of query, time of day, etc.).

At block 405, the server identifies a data field(s) or computational resource for each of the sub-queries. For example, in a sub-query for flights by price, the data fields for the sub-queries includes departure airport, destination airport, date of departure, date of arrival, time of departure, time of arrival, flight number, flight price, etc. Dependencies are not necessarily limited to sub-queries for data fields. A sub-query may be submitted to a data source that computes (“computational resource”) a result based on other sub-query results. For example, prices for flights may be computed dynamically based on current seat availability, current travel trends, current passenger club status, etc. A computational resource can be a particular machine that performs computations for a query, a particular software or service that performs computations for the query, etc.

At block 406, the server traverses a dependency graph with an identifier of the data field or computational resource, and records indications of any dependencies while traversing the dependency graph. While traversing the dependency graph, the server may discover that a data field or computational resource is dependent on multiple other computational resources or data fields. For example, the server traverses the dependency graph with a data field identifier. A data field can be independent of other data fields, dependent on other independent data field(s) or dependent on other dependent data field(s). A separate dependency graph can be used for data fields and computational resources, or the dependency information can be integrated into a single dependency graph. Regardless, a server determines whether a result for a sub-query is dependent on a result of another sub-query.

At block 407, the server determines if any dependencies were detected for the sub-query. For example, the server reads a data structure generated to track a path through the dependency graph to a data field of the sub-query. If the path has more than one non-root node indicated, then the server detects a dependency. If the server did not detect any dependencies for the sub-query, then control flows to block 411. If the server detected dependencies for the sub-query, then control flows to block 409.

At block 409, the server classifies the sub-query as a dependent sub-query. From block 409, the control flows to block 413.

At block 411, the server classifies the sub-query as an independent sub-query. From block 411, the control flows to block 413.

At block 413, the server checks if all sub-queries have been classified as independent or dependent sub-queries. If all the sub-queries have not been classified, control flows to block 405. If all the sub-queries have been classified, the decompose query process concludes.

In some embodiments, the classification of sub-queries is used to help in determining placeholders. In some embodiments, the classification of sub-queries is used to communicate the sub-queries. For example, a search tool, whether implemented on a client, server, or both, transmits the sub-queries in accordance with the classifications. In the case of a sub-query with multiple levels of dependency, the server or client can prioritize the independent sub-query and then intervening dependent sub-queries over the ultimate dependent sub-query.

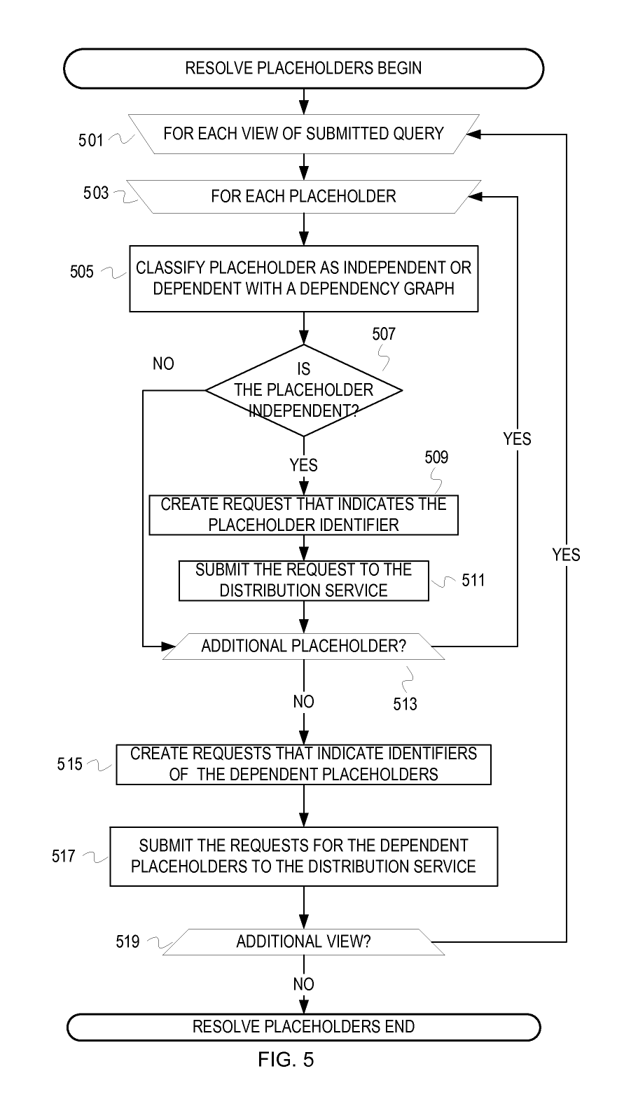

FIG. 5 illustrates a flow diagram of example operations to resolve placeholders using a dependency graph. The client replaces placeholders with sub-query results as the sub-query results are received from a result distribution service.

At block 501, a search tool begins processing for each data view of a submitted query. As discussed above, a query submitted by a client may be associated with multiple data views for a result(s) to the query.

At block 503, the search tool begins processing for each placeholder of the data view being processed.

At block 505, the search tool classifies the placeholder as independent or dependent using a dependency graph. The search tool uses a dependency graph that provides information about the dependencies of placeholders. For example, the dependency graph indicates dependencies between placeholder identifiers based on the dependencies of the corresponding data sources, data fields, or computational resources.

At block 507, the search tool determines whether the placeholder was classified as independent. If the placeholder was classified as independent, then control flows to block 509. Otherwise, control flows to block 513.

At block 509, the search tool creates a request that indicates the placeholder identifier. For example, the search tool creates a representational state transfer (ReST) request that encodes the placeholder identifier.

At block 511, the search tool submits the request to the distribution service. For example, the search tool instantiates a thread to submit the request to the distribution service and wait for a response. The distribution service will respond with a result to resolve the placeholder when the distribution service receives the result. The distribution service can implement any one of servlets, Java® server pages, Active Server Pages, Enterprise server bus, etc., to respond to the requests from the search tool.

At block 513, the search tool determines if there are additional placeholders of the data view to process. If not, then control flows to block 515. If there are additional placeholders, then control flows back to block 503.

At block 515, the search tool creates requests that indicate identifiers of the dependent placeholders. As with the independent placeholders, the search tool creates ReST requests that indicates the placeholder identifiers, for example.

At block 517, the search tool submits the requests for the dependent placeholders to the distribution service.

At block 519, the search tool determines whether there is an additional data view to process. If not, then the resolve placeholder process concludes. If the search tool determines there is an additional data view to process, then control flow back to block 501. In some embodiments, additional data views become available as requests to sub-queries are received. As the search tool receives responses with sub-query results that indicate placeholder identifiers, the corresponding placeholders are replaced.

Although the example operations of FIG. 5 use the dependency graph to prioritize creation and transmission of requests for sub-query results to resolve placeholders, embodiments are not so limited. In some embodiments, the search tool uses dependency information to prioritize requests based on data views as well as placeholders. In other words, a search tool prioritizes aggregation of results for data views based on dependencies among the data views. In some embodiments, the search tool prioritizes data views with dependent information and does not use dependency information for placeholders. Moreover, embodiments do not necessarily decompose a query into sub-queries. A search tool can determine sub-queries that correspond to an initial query, and the dependencies among those sub-queries. For example, a search tool can anticipate alternative data views based on heuristics, user preference, and/or history. Using the example of an intellectual property search tool from earlier, the search tool determines that a user often requests a data view of foreign filed applications after querying for issued U.S. patents. The search tool does not decompose the query into a sub-query for disclosure numbers and then a sub-query for foreign filing matters. The search tool determines that the foreign filing data view employs a sub-query that corresponds to the initial query, because the foreign filing sub-query is at least dependent on a result of the initial query. The search tool determines that the foreign filing sub-query is also dependent on the sub-query for disclosure numbers, which is dependent on the result to the initial query.

The flowcharts depicted herein are provided as examples to aid in understanding the inventive subject matter, and should not be used to limit embodiments or claim scope. Embodiments can perform additional operations, fewer operations, different operations, and operations in a different order than depicted in the flowcharts of example operations. For instance, some embodiments perform additional operations to prioritize sub-queries and placeholders after determining their dependencies. Prioritizing can involve marking the placeholder or sub-query in accordance with dependency based order. Also, embodiments may not explicitly classify sub-queries and placeholders as dependent or independent. In some embodiments, a sub-query is submitted once it is determined to be independent, while dependent sub-queries are placed in a pool or holding structure until all independent sub-queries have been submitted. Some embodiments similarly process placeholders.

In some embodiments, a partial data view is not presented and the search tool uses the dependency graph to combine and arrange the sub-query results before the search tool presents a complete data view. In other embodiments partial data views are presented with unresolved placeholders, and placeholders are resolved subsequently.

Those of ordinary skill in the art should understand that the depicted flowcharts are examples to aid in understanding the inventive subject matter, and should not be used to limit the scope of the claims. Embodiments can perform additional operations not depicted, fewer than the depicted operations, the operations in a different order, the operations in parallel, etc.

As will be appreciated by one skilled in the art, aspects of the present inventive subject matter may be embodied as a system, method or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a programmable device or programmable data processing apparatus, examples of which include a computer, personal digital assistant, phone, small form factor computer, tablet, etc., to cause a series of operational steps to be performed on the programmable device to produce a computer implemented process such that the instructions which execute on the programmable device provides processes for implementing the functions/acts specified in the flowcharts and/or block diagram block or blocks.

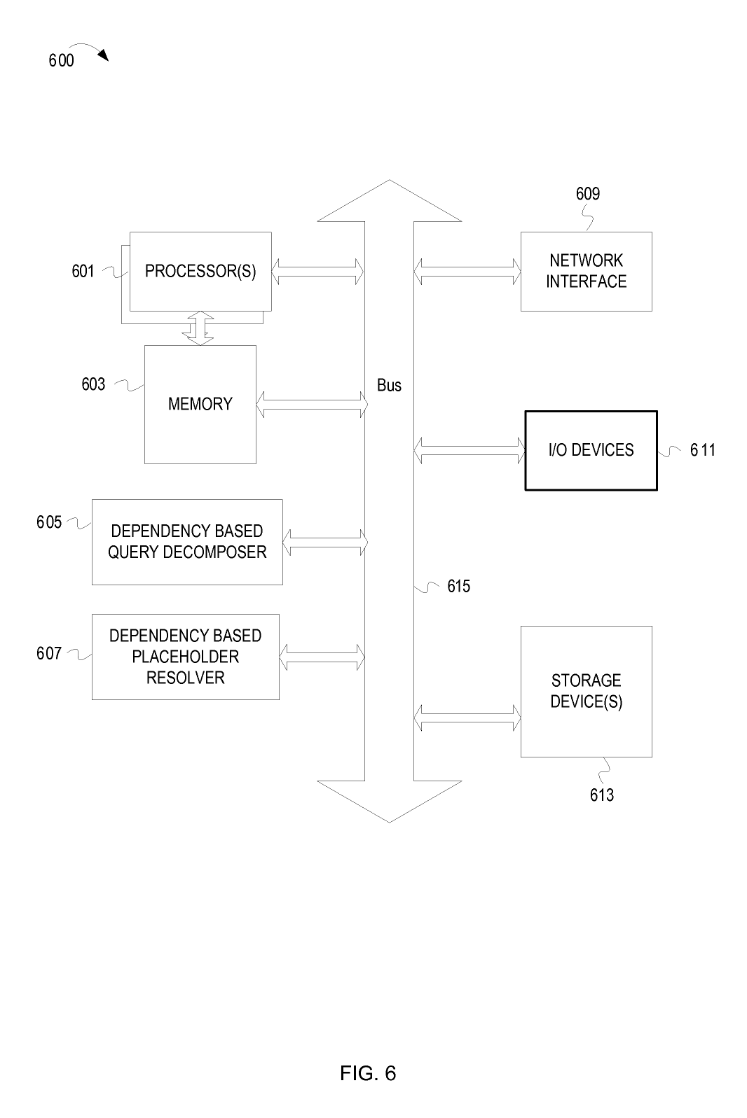

FIG. 6 depicts an example computer system. A computer system 600 includes a processor(s) 601, a memory 603, a dependency based query decomposer 605, a dependency based placeholder resolver 607, a network interface 609, I/O devices 611, a storage device(s) 613, which are all connected to a bus 615 in this example illustration. The memory 603 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The bus 615 (e.g., PCI, ISA, PCI-Express, HyperTransport®, InfiniBand®, NuBus, etc.), a network interface 609 (e.g., an ATM interface, an Ethernet interface, a Frame Relay interface, SONET interface, wireless interface, etc.), and a storage device(s) 613 (e.g., optical storage, magnetic storage, etc.) The dependency based query decomposer 605 and the dependency based placeholder resolver 607 embody functionality to implement embodiments described above. The dependency based query decomposer 605 includes and/or accesses dependency information about data sources for decomposing a query. The dependency based placeholder resolver 607 includes and/or accesses dependency information about data source elements corresponding to sub-query results, and replaces placeholders with sub-query results. Any one of these functionalities may be partially (or entirely) implemented in hardware and/or on the processor(s) 601. For example, the functionality may be implemented with an application specific integrated circuit, in logic implemented in the processor(s) 601, in a co-processor on a peripheral device or card, etc. In some embodiments, at least part of the functionality of the dependency based query decomposer 605 and the dependency based placeholder resolver 607 is carried out by execution of computer program instructions. Those computer program instructions may reside in any one of the memory 603, the storage device(s) 613, or another machine-readable storage medium within or coupled with the computer system 600. Further, realizations may include fewer or additional components not illustrated in FIG. 6 (e.g., video cards, audio cards, additional network interfaces, peripheral devices, etc.). The processor(s) 601, the storage device(s) 613, and the network interface 609 are coupled to the bus 615. Although illustrated as being coupled to the bus 615, the memory 603 may be coupled to the processor(s) 601.

While the embodiments are described with reference to various implementations and exploitations, it will be understood that these embodiments are illustrative and that the scope of the inventive subject matter is not limited to them. In general, techniques for processing of asynchronous results for a search query received by client as described herein may be implemented with facilities consistent with any hardware system or hardware systems. Many variations, modifications, additions, and improvements are possible. For instance, examples are described with reference to ReSTful services, but embodiments are not so limited. Embodiments can use Web services (e.g., SOAP, WDSL, etc.) and Remote Procedure Calls.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining a plurality of sub-queries from a query submitted to a search tool;
for each of the plurality of sub-queries, determining dependencies among the plurality of sub-queries using dependency information, wherein the dependency information indicates dependencies among the plurality of sub-queries based on at least one of structure of a plurality of data sources corresponding to the plurality of sub-queries and structures of a plurality of data views of query results provided by the search tool;
creating placeholders for expected results of at least a subset of the plurality of sub-queries that are dependent sub-queries, wherein said creating the placeholders comprises creating identifiers for the placeholders;
registering the placeholders with a distribution service using the placeholder identifiers, wherein the distribution service operates as an intermediary posting facility for results of the subset of the plurality of sub-queries to be supplied to a requestor associated with the query;
for each of the subset of the plurality of sub-queries, generating a modified sub-query that indicates the identifier for the placeholder that corresponds to the sub-query; and
submitting the modified sub-queries to appropriate ones of the plurality of data sources in accordance with the dependencies among the plurality of sub-queries.

2. The method of claim 1, wherein said determining the plurality of sub-queries from the query comprises:
decomposing the query into a first set of sub-queries of the plurality of sub-queries.

3. The method of claim 1, wherein said determining the plurality of sub-queries from the query comprises:
determining an alternative data view that corresponds to an initial data view of results from the query; and
determining a first set of sub-queries of the plurality of sub-queries to retrieve data for the alternative data view.

4. The method of claim 3, wherein said determining the alternative data view that corresponds to the initial data view comprises one of reading configuration data of the search tool that indicates the alternative data view for the initial data view, reading data that indicates the alternative data view as likely to be requested after the initial data view is provided, and detecting an option or explicit request for the alternative data view in metadata of the query.

5. The method of claim 1 further comprising prioritizing the plurality of sub-queries in accordance with the determined dependencies, wherein submitting the modified sub-queries to appropriate ones of the plurality of data sources in accordance with the dependencies among the plurality of sub-queries comprises submitting the modified sub-queries in an order that comports with said prioritizing.

6. The method of claim 1 further comprising loading the dependency information, wherein the dependency information is encoded one of a configuration file accessible by the search tool and the search tool.

7. The method of claim 1, wherein the plurality of data sources are predefined for the search tool.

8. The method of claim 1 further comprising:
analyzing code of the search tool to determine the structures of the plurality of data views; and
creating the dependency information based, at least in part, on the structures of the plurality of data views.

9. A computer program product for prioritizing replacement of placeholders based on dependency information, the computer program product comprising:
a computer readable storage medium having computer usable program code embodied therewith, the computer usable program code comprising a computer usable program code configured to:
determine dependencies of a plurality of placeholders used in a plurality of data views provided by a search tool to present results of sub-queries, wherein the dependencies are determined with dependency information that is based, at least in part, on structures of the plurality of data views;
for each of the plurality of placeholders in accordance with the dependencies,
generate a request for a sub-query result that corresponds to the placeholder, wherein the request indicates an identifier for the placeholder; and
submit the request to a result distribution service, wherein the result distribution service operates as a posting facility for results of the plurality of sub-queries, which are provided asynchronously to the result distribution service; and
replace the placeholders as the corresponding sub-query results are received from the result distribution service.

10. The computer program product of claim 9, wherein the computer usable program code is further configured to:
analyze program code of the search tool to determine the structures of the plurality of data views; and
create the dependency information based, at least in part, on the structures of the plurality of data views.

11. The computer program product of claim 9, wherein the computer usable program code is further configured to prioritize the plurality of placeholders in accordance with the dependencies.

12. A computer program product for prioritizing sub-queries from a search tool, the computer program product comprising:
a computer readable storage medium having computer usable program code embodied therewith, the computer usable program code comprising a computer usable program code configured to:
determine a plurality of sub-queries from a query submitted to the search tool;
for each of the plurality of sub-queries, determine dependencies among the plurality of sub-queries using dependency information, wherein the dependency information indicates dependencies among the plurality of sub-queries based on at least one of structure of a plurality of data sources corresponding to the plurality of sub-queries and structures of a plurality of data views of query results provided by the search tool;
create placeholders for expected results of at least a subset of the plurality of sub-queries that are dependent sub-queries, wherein the computer usable program code configured to create the placeholders comprises the computers usable program code configured to create identifiers for the placeholders;
register the placeholders with a distribution service using the placeholder identifiers, wherein the distribution service operates as a posting facility for results of the subset of the plurality of sub-queries to be supplied to a requestor associated with the query;
for each of the subset of the plurality of sub-queries, generate a modified sub-query that indicates the identifier for the placeholder that corresponds to the sub-query; and
submit the modified sub-queries to appropriate ones of the plurality of data sources in accordance with the dependencies among the plurality of sub-queries.

13. The computer program product of claim 1, wherein the computer usable program code configured to determine the plurality of sub-queries from the query comprises the computer usable program code configured to:
decompose the query into a first set of sub-queries of the plurality of sub-queries.

14. The computer program product of claim 12, wherein the computer usable program code configured to determine the plurality of sub-queries from the query comprises the computer usable program code configured to:
determine an alternative data view that corresponds to an initial data view of results from the query; and
determine a first set of sub-queries of the plurality of sub-queries to retrieve data for the alternative data view.

15. The computer program product of claim 14, wherein the computer usable program code configured to determine the alternative data view that corresponds to the initial data view comprises the computer usable program code configured to do one of read configuration data of the search tool that indicates the alternative data view for the initial data view, read data that indicates the alternative data view as likely to be requested after the initial data view is provided, and detect an option or explicit request for the alternative data view in metadata of the query.

16. The computer program product of claim 12, wherein the computer usable program code is further configured to prioritize the plurality of sub-queries in accordance with the determined dependencies, wherein the computer usable program code configured to submit the modified sub-queries to appropriate ones of the plurality of data sources in accordance with the dependencies among the plurality of sub-queries comprises the computer usable program code being configured to submit the modified sub-queries in an order that comports with said prioritizing.

17. The computer program product of claim 12, wherein the plurality of data sources are predefined for the search tool.

18. The computer program product of claim 12, wherein the computer usable program code is further configured to:
analyze code of the search tool to determine the structures of the plurality of data views; and
create the dependency information based, at least in part, on the structures of the plurality of data views.

19. An apparatus for prioritizing asynchronously processed sub-queries of a search tool, the apparatus comprising:
a processor;
a network interface; and
a dependency based query decomposes configured to,
determine a plurality of sub-queries from a query submitted to the search tool;
for each of the plurality of sub-queries, determine dependencies among the plurality of sub-queries using dependency information, wherein the dependency information indicates dependencies among the plurality of sub-queries based on at least one of structure of a plurality of data sources corresponding to the plurality of sub-queries and structures of a plurality of data views of query results provided by the search tool;
create placeholders for expected results of at least a subset of the plurality of sub-queries that are dependent sub-queries, wherein the computer usable program code configured to create the placeholders comprises the computers usable program code configured to create identifiers for the placeholders;
register the placeholders with a distribution service using the placeholder identifiers, wherein the distribution service operates as a posting facility for results of the subset of the plurality of sub-queries to be supplied to a requestor associated with the query;
for each of the subset of the plurality of sub-queries, generate a modified sub-query that indicates the identifier for the placeholder that corresponds to the sub-query; and
submit the modified sub-queries to appropriate ones of the plurality of data sources in accordance with the dependencies among the plurality of sub-queries.

20. The apparatus of claim 19 further comprising a machine-readable storage medium encoded with computer usable program code executable by the processor, wherein the computer usable program code embodies the dependency based query decomposer.
